(19) United States
(12) Patent Application Publication
(10) Pub. No.: US 2002/0133717 A1
(43) Pub. Date: Sep. 19, 2002

(54) Physical switched network security

(76) Inventors: Bernard M. Ciongoli, Totowa, NJ (US); Salvatore Grisafi, Naples, FL (US)

Correspondence Address: Gary S. Engelson, WOLF, GREENFIELDS & SACKS, P.C., Federal Reserve Plaza, 600 Atlantic Avenue, Boston, MA, 02210-2211, US

(21) Appl. No.: 09/808,102

(22) Filed: Mar. 13, 2001

(51) Int. Cl. G06F 11/30

(52) U.S. Cl. 713/201

(57) ABSTRACT

A security system for a communications network includes a system which audits and monitors network activity for an intruder. The system also includes a circuit switch which makes and breaks a physical connection between an external portion of the communications network and a private portion of the communications network. The auditing and monitoring system is connected to the circuit switch, preferably through a back channel inaccessible to an intruder, to control the circuit switch to disconnect the intruder from the private portion of the communications network and to connect the intruder to a decoy in a substantially undetectable manner.

### FIELD OF THE INVENTION

The present invention relates to security systems for communications networks. More particularly, the invention relates to preventing access to private network resources by intruders and to catching and identifying intruders.

### BACKGROUND OF THE INVENTION

Conventional security systems for communications networks rely largely on intrusion detection, followed by conventional trap and trace techniques known from the telecommunications arts.

Conventional systems include a security computer system positioned within a network and running specialized software so as to detect suspicious activity attributed to an intruder, hacker or attacker. When such suspicious activity is detected, the security computer system sends a message using the Simple Network Management Protocol (SNMP) to a security technician's workstation. The security technician can then perform manual disconnection or re-routing of the intruder to a decoy system so the intruder can be trapped and traced. However, such manual operations are very slow and detectable by the intruder. Therefore, the intruder can often elude the trap and trace. In some instances, the security technician can reprogram a packet switch device to re-route the intruder to a decoy system. However, even such re-routing is slow and detectable to the intruder. Moreover, such fully digital, virtual switches as packet switches, can be attacked and compromised by the intruder, as well, thus rendering ineffective any defense against the intruder other than manual disconnection.

### SUMMARY OF THE INVENTION

Accordingly, it is a general goal of the present invention to provide an improved security system for a physically switched network.

According to one aspect of the invention, there is provided a system for securing a private network of computer resources accessible to users of an external communications network, comprising: a private network gateway, and a circuit switch; the private network gateway connected in series with the circuit switch between the external communications network and the private network, and the private network gateway including an intruder detector which produces an alarm output when intruder activity is detected; and the circuit switch selectively disconnecting the external communications network from the private network responsive to the alarm output of the intruder detector.

Numerous variations of this aspect of the invention are possible. For example, the system may further comprise: a decoy computer resource connected to the circuit switch; the circuit switch selectively connecting the private network gateway to the decoy computer resource responsive to the alarm output of the intruder detector. In accordance with another variation, the circuit switch transfers the connection of the private network gateway from the private network to the decoy computer resource in a time period not noticeable to a human user. In accordance with yet other variations, the time period is less than 100 mS, less than 100 μS, less than 100 nS, or even about 90 nS. The circuit switch can connect a digital input signal to a digital output signal through a digital circuit switch matrix, or can connect an input signal to an output signal through an analog circuit switch matrix, or can connect an optical input signal to an optical output signal through an optical circuit switch matrix. Finally, the circuit switch can be located on premises containing equipment of the external communications network, or the circuit switch can be located on premises containing equipment of the private network.

According to another aspect of the invention, there is a method of securing a private network of computer resources accessible to users of an external communications network, comprising: detecting an intruder to the private network from the external communications network; generating an alarm signal responsive to the step of detecting; and reconnecting the intruder from the private network to a decoy resource in a time period not noticeable to the intruder. As with the first aspect of the invention, the time period may be less than 100 mS, less than 100 μS, less than 100 nS, or indeed may be about 90 nS.

### BRIEF DESCRIPTION OF THE DRAWINGS

In the drawings, in which like reference designations indicate like elements:

FIG. 1 is a block diagram of a first embodiment of the invention; and

FIG. 2 is a block diagram of a second embodiment of the invention.

### DETAILED DESCRIPTION

The present invention is now illustrated by the following description of some embodiments thereof, which should be read together with the drawings.

In this discussion and the following claims, a number of terms are used which are intended to have the meanings given here. Users are individuals or organizations who communicate, process data, etc., using computers interconnected through one or more communications networks. Communications networks are systems of communication equipment which interconnect plural computers or other network resources in such a manner that a user can selectively communicate with another user's computer or a network resource connected to the communications network. Communications networks include, but are not limited to the public switched telephone network (PSTN), which may be operated by a competitive local exchange carrier (CLEC), networks of computers operated by an internet service provider (ISP), the internet worldwide computer network, various local area networks (LANs) wide area networks (WANs) and the like. Private networks are communications networks which are intended for the use of a private, authorized group of users. Private networks may be connected to public networks, referred to as external networks, through access equipment such as a gateway. Intruders are individuals or organizations who attempt to or in fact obtain unauthorized access to computers or other network resources. Intruders, also sometimes referred to as hackers, crackers or attackers may obtain such unauthorized access directly, for example by connecting to a target computer or resource through the communications network or indirectly, by launching a virus, worm or other malicious software program which attempts to reach the target.

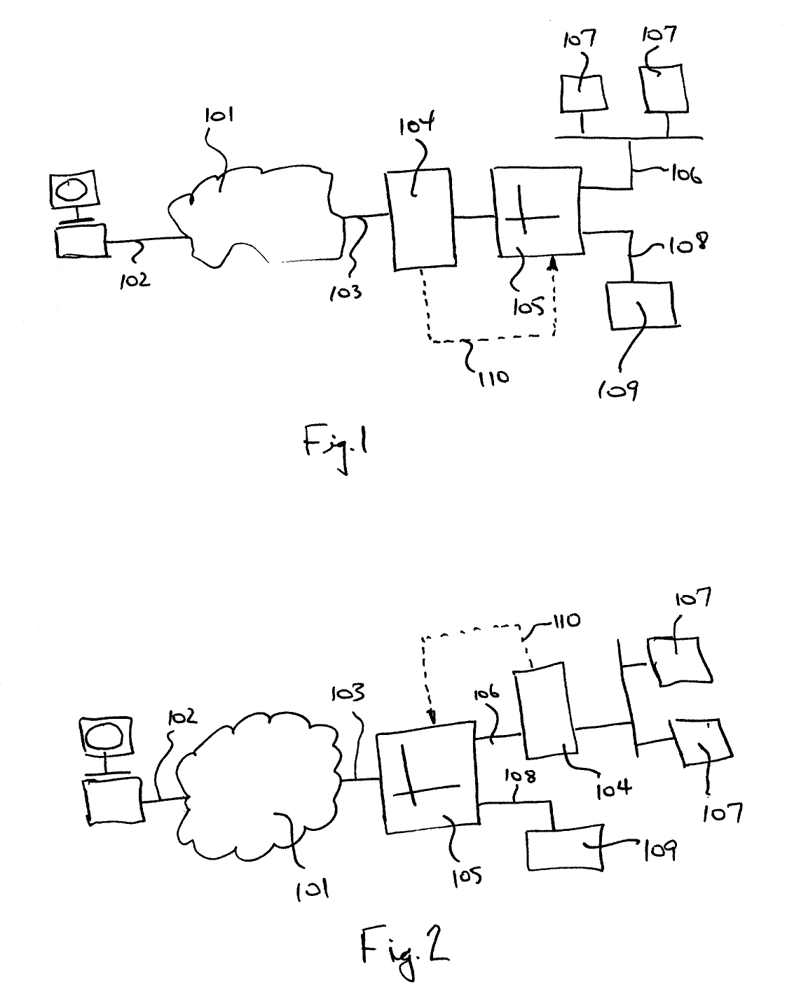

The high level block diagram of FIG. 1 illustrates a first embodiment of the invention. In this embodiment, a user connects to an external network 101 through a user circuit 102. The external network 101 includes a private network circuit 103 connected to a private network gateway 104. The private network gateway 104, in turn, is connected to a circuit switch 105. One circuit 106 which the circuit switch 105 can connect to the private network gateway 104 is connected to a network of private network computers or other resources 107. Another circuit 108 which the circuit switch 105 can connect to the private network gateway 104 is connected to a decoy resource 109, also referred to as a “honey pot.”

Operation of the system illustrated in FIG. 1 is now described.

A user who desires to obtain access to a private network computer or resource 107 connects through the external network 101 to the private network gateway 104, using conventional communication services, such as a dial-up modem or a high-speed data circuit, for example a Ti line, digital subscriber (DSL) line, integrated services digital network (ISDN) line, in-band Ethernet, etc. The private network gateway 104 can be a conventional piece of equipment such as a Cisco or Bay Networks router including, for example, firewall software (e.g. from Checkpoint), access authorization software and the like. The private network gateway 104 should also include software capable of determining whether an access request that appears to the conventional access authorization software to be authorized is, in fact, an access by an intruder. Such software is known, operating by auditing and monitoring network activity. An example, useful in connection with the present invention, is SilentRunne™, available from Raytheon Company, Marlborough, Mass. SilentRunner, and other known network security auditing and monitoring software issues conventional intruder alarms under the Simple Network Management Protocol (SNMP). In the illustrative embodiment of the present invention, the SNMP alarm message is carried through a back channel 110, not through the communications network where it could be susceptible to attack, to the circuit switch 105. While the back channel 110 is preferred, communication could be through a circuit of the network, but such a connection could be susceptible to attack by the intruder. The circuit switch 105 of this embodiment of the invention can be, for example, a DynaTraX™ switch available from Tech Laboratories, Inc., of North Haledon, N.J. Such a switch establishes physical circuit connections from input circuits to output circuits, rather than the virtual connections often used in modern packet switched networks, yet is software controlled. When the SNMP alarm message is received by the circuit switch 105, the intruder can be disconnected from the circuit 106 on which the private network computers or network resources 107 reside, and optionally reconnected to the circuit 108 on which the honey pot 108 resides. The DynaTraX circuit switch 105 can accomplish this switching in a period of time not discernible to a user, for example faster than 100 mS. The DynaTraX circuit switch 105 can also accomplish this switching in a period of time such as 100 μS not discernible to a software program or a period of time such as 100 nS not discernible to software or hardware designed to detect such activity. The DynaTraX circuit switch 105 can accomplish this switching in as little as about 90 nS. Thus, an intruder is redirected to the honey pot in a manner that will not alert the intruder to the ruse. Therefore, the intruder will continue to engage in (now harmless) malicious activity, while a conventional trap and trace of the circuit on which the intruder has entered can be performed. Therefore, the intruder can be identified and caught.

A second embodiment of the invention is illustrated by the block diagram of FIG. 2. In this embodiment, a user connects to an external network 101 through a user circuit 102. The external network 101 includes a private network circuit 103 connected to a circuit switch 105. The circuit switch 105, in turn, has one circuit 106 connected to a private network gateway 104. The private network gateway 104 is then connected to a network of private network computers or other resources 107. The circuit switch has another circuit 108 which is connected to a decoy resource109, also referred to as a “honey pot.” As can be seen, this embodiment employs the same elements as the first embodiment, but arranged in a different topology.

Operation of the second embodiment is substantially the same as that of the first embodiment, except as now described. In the first embodiment, the circuit switch 105 need not provide a default connection. However, in order for authentication and monitoring to take place at the private network gateway 104, the circuit switch 105 must provide a default connection to circuit 106. When redirection to the honey pot occurs, monitoring by the private network gateway 104 is consequently cut off. However, such monitoring need not be essential to the trap and trace to be performed.

The present invention has now been described in connection with a number of specific embodiments thereof. However, numerous modifications, which are contemplated as falling within the scope of the present invention, should now be apparent to those skilled in the art. Therefore, it is intended that the scope of the present invention be limited only by the scope of the claims appended hereto.

What is claimed is:

1. A system for securing a private network of computer resources accessible to users of an external communications network, comprising:
a private network gateway, and
a circuit switch;
the private network gateway connected in series with the circuit switch between the external communications network and the private network, and the private network gateway including an intruder detector which produces an alarm output when intruder activity is detected; and
the circuit switch selectively disconnecting the external communications network from the private network responsive to the alarm output of the intruder detector.

2. The system of claim 1, further comprising:
a decoy computer resource connected to the circuit switch;
the circuit switch selectively connecting the private network gateway to the decoy computer resource responsive to the alarm output of the intruder detector.

3. The system of claim 2, wherein the circuit switch transfers the connection of the private network gateway from the private network to the decoy computer resource in a time period not noticeable to a human user.

4. The system of claim 3, wherein the time period is less than 100 mS.

5. The system of claim 4, wherein the time period is less than 100 μS.

6. The system of claim 5, wherein the time period is less than 100 nS.

7. The system of claim 6, wherein the time period is about 90 nS.

8. The system of claim 1, wherein the circuit switch connects a digital input signal to a digital output signal through a digital circuit switch matrix.

9. The system of claim 1, wherein the circuit switch connects an input signal to an output signal through an analog circuit switch matrix.

10. The system of claim 1, wherein the circuit switch connects an optical input signal to an optical output signal through an optical circuit switch matrix.

11. The system of claim 1, wherein the circuit switch is located on premises containing equipment of the external communications network.

12. The system of claim 1, wherein the circuit switch is located on premises containing equipment of the private network.

13. A method of securing a private network of computer resources accessible to users of an external communications network, comprising:
detecting an intruder to the private network from the external communications network;
generating an alarm signal responsive to the step of detecting; and
reconnecting the intruder from the private network to a decoy resource in a time period not noticeable to the intruder.

14. The system of claim 13, wherein the time period is less than 100 mS.

15. The system of claim 14, wherein the time period is less than 100 μS.

16. The system of claim 15, wherein the time period is less than 100 nS.

17. The system of claim 16, wherein the time period is about 90 nS.
